(19) United States
(12) Patent Application Publication
(10) Pub. No.: US 2026/0019802 A1
(43) Pub. Date: Jan. 15, 2026

(54) METHOD FOR ENHANCING PRIVACY IN AN ACCESS NETWORK

(71) Applicant: Deutsche Telekom AG, Bonn (DE)

(72) Inventor: Josep COLOM IKUNO, Korneuburg (AT)

(21) Appl. No.: 18/993,006

(22) PCT Filed: Jul. 18, 2023
(86) PCT No.: PCT/EP2023/069906

§ 371 Date: Jan. 10, 2025

(30) Foreign Application Priority Data
Jul. 29, 2022 (EP) 22187877.0

(51) Int. Cl. H04W 12/02; H04L 9/40; H04W 12/08

(52) U.S. Cl. CPC H04W 12/02; H04L 63/10; H04L 63/20; H04W 12/08

(57) ABSTRACT

A method for enhancing privacy in an access network (AN) includes: sending, by an Access Network Intelligent Controller (AN-IC) to an interface node, a request for an AN parameter related to the interface node; receiving, by the AN-IC from the interface node, an interface node message containing the requested AN parameter; receiving, by the AN-IC from an AN-IC application, a further request for the AN parameter; and matching, by the AN-IC, the further request to a policy element based on the information contained in the further message request or interface node message.

### CROSS-REFERENCE TO PRIOR APPLICATIONS

This application is a U.S. National Phase application under 35 U.S.C. § 371 of International Application No. PCT/EP2023/069906, filed on Jul. 18, 2023, and claims benefit to European Patent Application No. EP 22187877.0, filed on Jul. 29, 2022. The International Application was published in English on Feb. 1, 2024 as WO 2024/022893 A1 under PCT Article 21(2).

### FIELD

This invention relates to a method for enhancing privacy in an access network, and an access network therefor.

### BACKGROUND

A conventional 5G system model is illustrated in FIG. 1. As illustrated in FIG. 1, the conventional model divides the mobile network in two main parts: access network (AN) and core network (CN). The objective of the model is to provide the UE with connectivity towards a data network (DN). Going in more detail, the UE communicates with the AN via an interface, which is used for conveying both signaling information and data traffic. For example, the AN may be a radio access network (RAN) having a radio interface.

Conventional 3GPP standards define the RAN as including a set of gNBs, which are considered to be either a single, monolithic entity or a set of functional entities. FIG. 2 shows the RAN overall architecture according to 3GPP TS 38.401. Further splits are also defined by 3GPP, such as a separation between control plane and user plane for the control unit (CU) and/or distributed unit (DU).

The current state of the art for Open RAN systems is based on O-RAN Alliance's specifications. O-RAN Alliance's specifications aim at specifying a build on top of 3GPP architecture and interfaces and further define interfaces and functional entities. The disaggregated RAN architecture based on CU/DU separation from 3GPP is the basis for the RAN architecture from O-RAN Alliance's specifications.

On top of the 3GPP-defined interfaces, the O-RAN specifications define additional interfaces. The most known additional interface of all is the open fronthaul (Open FH). The Open FH allows interoperability between different DU and radio unit (RU) vendors.

One of the main aspects of the O-RAN architecture is the availability of new functionality named the non-real time and near-real time RAN Intelligent Controllers (RICs). In detail, the O-RAN architecture supports additional control loops that are capable of plugging in logic tasked with steering RAN functionality:
non-RT (non-real time) control loops: via O1 interface between SMO and O-RAN components. The SMO hosts a non-RT RIC.
near-RT (near-real time) control loops: via E2 interface between near-RT RIC and O-RAN components.

Real time (RT) control loops do not contain open interfaces as per the current O-RAN specification. In both the near-RT and non-RT RIC cases, additional logic is plugged into the system via “Apps”. In particular, the term “xApps” is used in the near-RT case and the term “rApps” is used in the case of non-RT.

FIG. 3 illustrates an example of a O-RAN architecture. As shown in FIG. 3, the continued lines illustrate the O-RAN interfaces, whereas the dashed lines show the 3GPP interfaces. Furthermore, the circle: “1” illustrates the non-real time control loops; “2” illustrates the near-real time control loops; and “3” illustrates the real time control loops. The typical ranges for these loops are the following:

$$non - RT control loops \geq 1 s$$

$$10 ms \leq near - RT control loops < 1 s$$

$$RT control loops < 10 ms$$

A goal of non-RT RIC is to support intelligent RAN optimization by providing policy-based guidance, machine learning (ML) model management and enrichment information to the near-RT RIC function so that the RAN can optimize, e.g., RRM under certain conditions. It can also perform intelligent radio resource management function in non-real-time interval (i.e., greater than 1 second, such as switching off cells for energy saving). The non-RT RIC comprises two sub-functions:
non-RT RIC Framework—Functionality internal to the SMO framework that logically terminates the A1 interface and exposes the required services to rApps through its R1 interface.
non-RT RIC applications (rApps)—Modular applications that leverage the functionality exposed by the non-RT RIC Framework to perform RAN optimization and other functions. Services exposed to rApps via the R1 interface enable rApps to obtain information and trigger actions (e.g., policies, re-configuration) through the A1, O1, O2 and Open FH M-Plane related services.

A common application of rApps is in the field of self-organizing network (SON), where a network is capable of detecting configuration conflicts and resolve these, e.g. avoiding physical cell identity (PCI) conflicts when deploying a radio network.

The near-RT RIC is a logical function that enables near real-time control and optimization of E2 nodes functions and resources via fine-grained data collection and actions over the E2 interface with control loops in the order of 10 ms-1 s. E2 nodes comprise the logical endpoint of the E2 interface on the RAN component, e.g. a O-DU can contain a E2 node allowing a near-RT RIC to steer certain functionality in the O-DU such as access control to the cell. near-RT RIC functionality is, analogously to the non-RT RIC, composed of:
Near-RT RIC framework
The near-RT RIC hosts one or more xApps that use E2 interface to collect near real-time information (e.g. on a UE basis or a cell basis) and provide value added services. The near-RT RIC control over the E2 nodes is steered via the policies and the enrichment data provided via A1 from the non-RT RIC.

Some examples of functionality that can be implemented via xApps are: steering of specific users to certain cells and/or frequencies; adjusting QoS/QoE for specific users; MIMO beamforming; influence Radio Resource Management (RRM) functionality for certain users, e.g. access control; and gather mobility data from users, which can be used in AI/ML models for user prediction.

The near-RT RIC hosts xApp-based functionality. E2 nodes are the termination points of the E2 interface. In the current version of the specification, O-RAN nodes terminating E2 interface are for:
NR access: O-CU-CP, O-CU-UP, O-DU or any combination,
E-UTRA access: O-eNB

The functionalities supported by the E2 interface are currently based exclusively on control plane protocols. The E2 functions are grouped into the following categories:
Near-RT RIC Services (REPORT, INSERT, CONTROL and POLICY).
Near-RT RIC support functions, which include, e.g., E2 Interface Management (E2 Setup, E2 Reset, Reporting of General Error Situations etc.) and Near-RT RIC Service Update (capability exchange related to the list of E2 node functions exposed over E2 etc.).

The xApps access information from the E2 nodes via the Shared Data Layer (SDL). The SDL is accessed via subscription management. In sum, the xApp subscription management (as defined in O-RAN WG3 RIC Architecture, clause 6.2.2):
manages subscriptions from xApps to E2 nodes;
enforces authorization of policies controlling xApp access to messages;
enables merging of identical subscriptions from different xApps into a single subscription toward an E2 node.

The O-RAN RIC API describes a Subscribe Information procedure and an Information Push procedure. In addition, as an alternative to parameter subscription, information can also be explicitly fetched.

In terms of information being exchanged, the following parameters (from the current O-RAN specification) are relevant for the retrieval (via subscription or fetch) of E2 node parameters regardless of the direction of the request and/or push procedure (e.g. direction of the xApp towards near-RT RIC platform, direction of the near-RT RIC platform towards xApp, direction of the xApp towards near-RT RIC platform, direction of the near-RT RIC platform towards xApp): message type, xApp request ID, information type, delivery method, subscribe filter list, filter definition, information block, modification type, information unit, fetch filter list, filter definition.

The xApp request ID IE uniquely identifies each request made by the xApp. For SDL subscriptions, the xApp request ID is also used as the “subscription identifier” and is used in all related Information Push and Information Update Notify messages.

Filters and/or Information Type reference to one of the following identifiers: E2Node ID, E2 Node Component Type, RAN function OID List.

From the perspective of the E2 node, the operations are similar. The information that is exchanged via this protocol stack over the E2 interface is defined by E2 Service Models (E2SMs), e.g. the KPM E2SM defined in the O-RAN WG3 E2SM-KPM specification. A E2SM can be considered a data model defining information that can be provided by the E2 node, as well as the format of the data within messages exchanged with the E2 node (e.g. lists, enumerations, number formats, string). Each E2SM definition is accompanied by a ASN file including an OID for the given RAN function ID, with the ASN file describing the data types supported by the E2SM. A E2 node may support more than one E2SM (e.g. KPI monitoring and RAN control). E2 nodes supporting the same set of E2SMs can be considered of being of the same type.

The same, or analogous concept (e.g., based on Open API descriptions for interface description) can be used with O-RAN interfaces other than E2 (e.g. A1, O1, O2, Open FH). Similarly, the O-RAN interfaces can be extended to not only RAN but also to cover other access network (AN) cases, such as a wired AN, in which nodes can additionally contain DSLAMs, broadband remote access server (BRAS) and/or other AN nodes not limited to radio.

The term Access Network Intelligent Controller (AN-IC) is thus used to generically refer to a RIC or analogous intelligent controller applied to a radio-based or non-radio-based access network. Similarly, applications running on an AN-IC (e.g. xApps, rApps) are referred to as AN-IC applications and the node terminating an AN-IC interface (e.g. E2 interface) is referred to as interface node (e.g. E2 node).

While the O-RAN Alliance specifications define a set of E2SMs, for E2SMs that are not specified (e.g. proprietary data models), the E2SM has to be known to the near-RT RIC and the xApp using it. Thus, it does not need to be known to other xApps not using the given E2SM. In generic terms, in the following description the E2SM is referred to as the interface node service model (INSM).

From the common E2SM parameters defined in the O-RAN WG3 E2SM specification, the following parameters are examples of identifiers that could lead to an identification and/or tracking within the 5GS of a given user:
1) UE NGAP ID
2) RAN UE ID
3) Cell ID (e.g. PCI)
4) Tracking Area

Additional parameters that could be used in future and are privacy-relevant are subscriber-related identifiers such as SUPI, SUCI, 5G-GUTI, S-NSSAI.

In view of the above, it is apparent that the functionality extension and modularity offered by deploying a near real-time (near-RT) RAN Intelligent Controller (RIC) or non-RT RIC is very powerful. Furthermore, the information gathered by an xApp/rApp or group of xApps/rApps could potentially be used for tracking and/or monitoring user behavior.

In a conventional specification, the RIC provides data to RIC applications (e.g. xApps, rApps), with the RIC applications being trusted to handle the information appropriately.

However, it is not yet possible to modify values requested by RIC applications to remove sensitive data, nor be able to obfuscate, e.g., anonymize, such data or otherwise generate data analogous to the original data before being received by the RIC application.

### SUMMARY

In an exemplary embodiment, the present invention provides a method for enhancing privacy in an access network (AN) comprising one or more AN components and an AN Intelligent Controller (AN-IC). At least one AN component contains an interface node. The AN-IC comprises: an AN-IC application configured to request and/or subscribe to one or more AN parameters from the interface node, via the AN-IC; one or more policy elements, each policy element containing a behavior to be applied to a matching requests or a related AN parameter, wherein the behavior corresponds to allowing/rejecting a request, modifying an AN parameter and/or generating a further AN parameter analogous to the AN parameter; and one or more logical connections between the AN-IC and one or more interface nodes. The method comprises: sending, by the AN-IC to the interface node, a request for an AN parameter related to the interface node; receiving, by the AN-IC from the interface node, an interface node message containing the requested AN parameter; receiving, by the AN-IC from the AN-IC application, a further request for the AN parameter; and matching, by the AN-IC, the further request to a policy element based on the information contained in the further message request or interface node message.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates the concept of a conventional 5G system model.

FIG. 2 illustrates the concept of an overall RAN.

FIG. 3 illustrates an example of an O-RAN architecture covering interfaces standardized by 3GPP.

FIG. 4 illustrates an example of parameters considered for AN-IC security/privacy policy according to an embodiment of the invention.

FIG. 5 illustrates an example method of the application of the security/privacy policy to received data from an interface node in accordance with an embodiment of the invention.

FIG. 6 illustrates an example method where the generation of synthetic data is not received from an interface node in accordance with an embodiment of the invention.

FIG. 7 illustrates an example method where modified data is written to the AN-IC Shared Data Layer or DB in accordance with an embodiment of the invention.

FIG. 8 illustrates an example method where data is modified prior to being sent to the application in accordance with an embodiment of the invention.

FIG. 9 illustrates an example method for enhancing privacy in an access network in accordance with an embodiment of the invention.

FIG. 10 illustrates another example method for enhancing privacy in an access network in accordance with another embodiment of the invention.

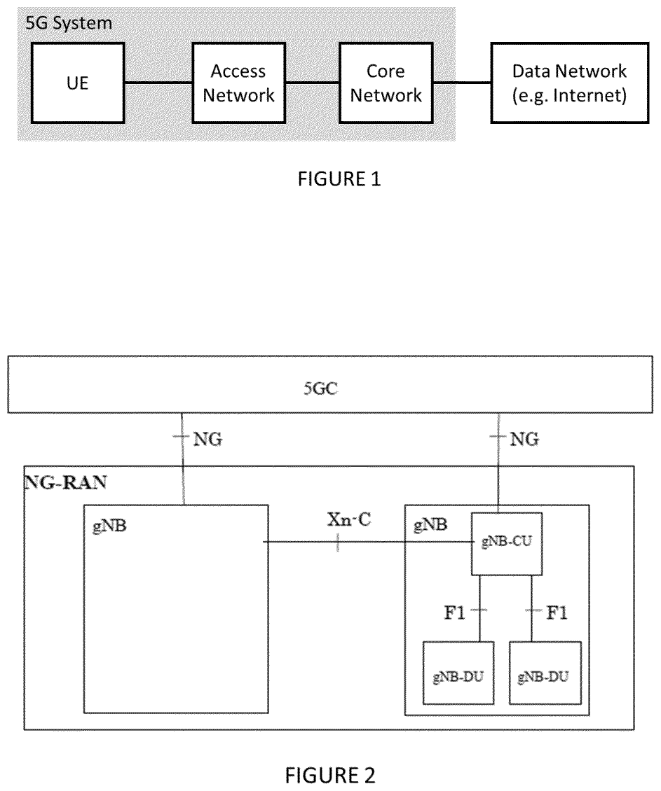

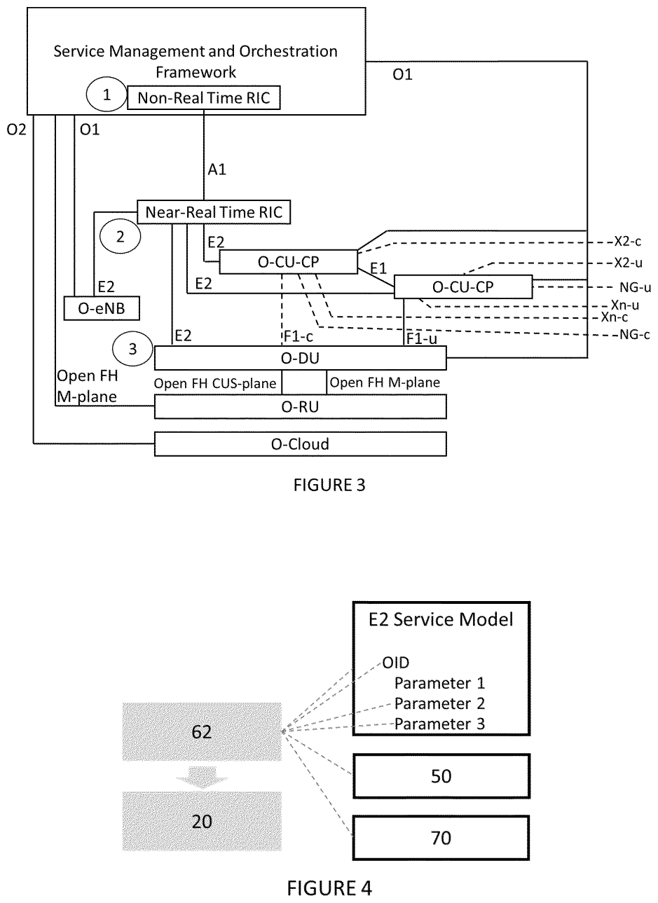

### DETAILED DESCRIPTION

Exemplary embodiments of the present invention add additional functionality for the RIC to enable transparent interception and modification of parameters enroute towards RIC applications. The objective of such modifications (e.g., obfuscating, anonymizing) being that in the case the information collected by a RIC application is misused by and/or via said application, that said information cannot be mapped back to the original data and, especially, cannot be mapped back to specific users of the AN.

According to the invention, an operator could achieve the ability to deploy such functionality so that it is possible to:
1) Modify values requested by RIC applications to remove sensitive data (i.e. not all requested information is available)
2) Alternatively, be able to obfuscate/anonymize such data before being received by the RIC application (i.e. requested information is available, albeit in a transformed form)

While with approach 1) the functionality of some RIC applications may be constrained, with approach 2) RIC application functionality should be possible to be maintained while not explicitly sharing sensitive data.

According to an aspect of the present invention, there is provided a method for enhancing privacy in an access network, AN, comprising one or more AN components and an AN Intelligent Controller, AN-IC, wherein at least an AN component contains an interface node, especially a E2 node, wherein an AN-IC is composed of at least: an AN-IC application configured to request and/or subscribe to one or more AN parameters from an interface node, via the AN-IC; one or more policy elements, each policy element containing a behavior to be applied to a matching requests or a related AN parameter, wherein behavior refers to allowing/rejecting a request, modifying an AN parameter and/or generating a further AN parameter analogous to the AN parameter; and one or more logical connections between the AN-IC and the interface nodes, especially a E2 interface, wherein the AN-IC is configured to match policy elements to matching requests, the method comprising the following steps: sending, by the AN-IC to an interface node, a request for an AN parameter related to the interface node; receiving, by the AN-IC from the interface node, an interface node message containing the requested AN parameter; receiving, by the AN-IC from the AN-IC application, a further request for the AN parameter; matching, by the AN-IC, the further request to a policy element based on the information contained in the further message request or interface node message, especially to at least one of: interface node and/or interface node type, especially an interface node identifier or an object identifier, OID identifying the type of the interface node, especially a E2 node and/or E2 Service Model, E2SM; requested AN parameter, especially an object identifier, OID identifying a variable within an interface node or within a E2 service model; and requester AN-IC application, especially an xApp application identifier or rApp application identifier.

Preferably, the method further comprises: sending, by the AN-IC to the AN-IC application, a message containing: if the matching behavior indicates generating a further AN parameter analogous to the AN parameter, a further AN parameter analogous to the AN parameter; if the matching behavior indicates modifying an AN parameter, a modified AN parameter derived from the AN parameter; and if the matching behavior indicates rejecting the request, a message rejecting the application request.

Preferably, the AN is a radio access network, RAN, wherein an AN component is one of a radio unit, RU; a central unit, CU; or a distributed unit, DU.

Preferably, modifying an AN parameter refers to replacing, removing, re-mapping, hashing, encrypting, obscuring or otherwise altering AN parameters or parts thereof, especially in the case of AN parameters referring to one or more identifiers related to: a subscriber, area, AN component, time, network identifier and/or network area.

Preferably the method, further comprises: applying, by the AN-IC, the behavior from the matching policy element to the received AN parameter.

Preferably, the AN-IC further comprises a Shared Data Layer, SDL, configured to store AN parameters, and the method further comprises storing, after the receiving step, by the AN-IC, the received AN parameter in the SDL.

Preferably the method, further comprises: retrieving, after the storing step, by the AN-IC, the AN parameter from the SDL; and applying, by the AN-IC, the behavior from the matching policy element to the retrieved AN parameter.

Preferably the method, further comprises: before the storing step, applying, by the AN-IC, the behavior from the matching policy element to the AN parameter; and after the storing step, retrieving, by the AN-IC, the AN parameter from the SDL.

According to another aspect of the present invention, there is provided a method for enhancing privacy in an access network, AN, comprising one or more AN components and an AN Intelligent Controller, AN-IC, wherein each AN component contains an interface node, especially a E2 node, wherein an AN-IC is composed of at least: an application configured to request and/or subscribe to one or more AN parameters from an interface node, via an AN-IC application; an AN-IC application configured to request and/or subscribe to one or more AN parameters from an interface node, via the AN-IC; one or more policy elements, each policy element containing a behavior to be applied to a matching requests or a related AN parameter, wherein behavior refers to allowing/rejecting a request, modifying an AN parameter and/or generating a further AN parameter analogous to the AN parameter; and one or more logical connections between the AN-IC and the interface nodes, especially a E2 interface, wherein the AN-IC application is configured to match policy elements to matching requests, the method comprising the following steps: sending, by the AN-IC to an interface node, a request for an AN parameter related to the interface node; receiving, by the AN-IC from an interface node, an interface node message containing the requested AN parameter; sending, by the application to the AN-IC application, an application request for a second AN parameter, wherein the second AN parameter relates to the AN parameter; receiving, by the AN-IC from the AN-IC application, a further request for the AN parameter, wherein the AN parameter relates to the second AN parameter; receiving, by the AN-IC application from the AN-IC, a message containing the AN parameter requested in the further request; matching, by the AN-IC application, the further request to a policy element based on the information contained in the application request for the second AN parameter, especially to at least one of: interface node and/or interface node type, especially an interface node identifier or an Object Identifier, OID identifying the type of the interface node, especially a E2 node and/or E2 Service Model, E2SM; requested AN parameter, especially an object identifier, OID identifying a variable within a interface node or within a E2 Service Model; and requester AN-IC application, especially an xApp application identifier or rApp application identifier.

Preferably, the method further comprises: sending, by the AN-IC application to the application, a message containing: if the matching behavior indicates generating a further AN parameter analogous to the AN parameter, a second further AN parameter analogous to the second AN parameter; if the matching behavior indicates modifying an AN parameter, a modified second AN parameter derived from the second AN parameter; and if the matching behavior indicates rejecting the request, a message rejecting the application request.

According to another aspect of the present invention, there is provided an access network, AN, comprising one or more AN components and an AN Intelligent Controller, AN-IC, wherein at least an AN component contains an interface node, especially a E2 node, wherein an AN-IC is composed of at least: an AN-IC application configured to request and/or subscribe to one or more AN parameters from an interface node, via the AN-IC; one or more policy elements, each policy element containing a behavior to be applied to a matching requests or a related AN parameter, wherein behavior refers to allowing/rejecting a request, modifying an AN parameter and/or generating a further AN parameter analogous to the AN parameter; and one or more logical connections between the AN-IC and the interface nodes, especially a E2 interface, wherein the AN-IC is configured to: match policy elements to matching requests; send, to an interface node, a request for an AN parameter related to the interface node (70); receive, from the interface node, an interface node message containing the requested AN parameter; receive, from the AN-IC application, a further request for the requested AN parameter; match the further request to a policy element based on the information contained in the further message request or interface node message, especially to at least one of an E2 Service Model, E2SM, such as one or more parameters belonging to the E2 Service Model; interface node, especially an interface node identifier or an object identifier, OID identifying the type of the interface node, especially a E2 node and/or E2 Service Model, E2SM; requested AN parameter, especially an object identifier, OID identifying a variable within an interface node or within a E2 Service Model; and requester AN-IC application, especially an xApp application identifier or rApp application identifier.

Preferably, the AN is a radio access network, RAN, wherein an AN component is one of a radio unit, RU; a central unit, CU; or a distributed unit, DU.

Preferably, the AN-IC is configured to send to the AN-IC application, a message containing: if the matching behavior indicates generating a further AN parameter analogous to the AN parameter, a further AN parameter analogous to the AN parameter; if the matching behavior indicates modifying an AN parameter, a modified AN parameter derived from the AN parameter; and if the matching behavior indicates rejecting the request, a message rejecting the application request.

Preferably, modifying an AN parameter refers to replacing, removing, re-mapping, hashing, encrypting, obscuring or otherwise altering AN parameters or parts thereof, especially in the case of AN parameters referring to one or more identifiers related to: a subscriber, area, AN component, time, network identifier and/or network area.

Preferably, the AN-IC is further configured to apply the behavior from the matching policy element to the AN parameter received from the interface node.

Preferably, the AN-IC further comprises a Shared Data Layer, SDL, configured to store AN parameters, and the AN-IC is further configured to: store, after receiving the further request for the requested AN parameter, the received AN parameter in the SDL; retrieve, the AN parameter from the SDL; apply the behavior from the matching policy element to the retrieved AN parameter.

Preferably, the AN-IC further comprises a Shared Data Layer, SDL, configured to store AN parameters, and the AN-IC is further configured to: apply, the behavior from the matching policy element to the AN parameter; store, after receiving the further request for the requested AN parameter, the received AN parameter in the SDL; and retrieve, by the AN-IC, the AN parameter from the SDL.

According to another aspect of the present invention, there is provided an access network, AN, comprising one or more AN components and an AN Intelligent Controller, AN-IC, wherein each AN component contains an interface node, especially a E2 node, wherein an AN-IC is composed of at least: an application configured to request and/or subscribe to one or more AN parameters from an interface node, via an AN-IC application; an AN-IC application configured to request and/or subscribe to one or more AN parameters from an interface node, via the AN-IC; one or more policy elements, each policy element containing a behavior to be applied to a matching requests or a related AN parameter, wherein behavior refers to allowing/rejecting a request, modifying an AN parameter and/or generating a further AN parameter analogous to the AN parameter; and one or more logical connections between the AN-IC and the interface nodes, especially a E2 interface, wherein: the AN-IC application is configured to match policy elements to matching requests; the AN-IC is configured to send to an interface node, a request for an AN parameter related to the interface node; the AN-IC is configured to receive from an interface node, an interface node message containing the requested AN parameter; the application is configured to send to the AN-IC application, an application request for a second AN parameter, wherein the second AN parameter relates to the AN parameter; the AN-IC is configured to receive from the AN-IC application, a further request for the AN parameter, wherein the AN parameter relates to the second AN parameter; the AN-IC application is configured to receive from the AN-IC a message containing the AN parameter requested in the further request; the AN-IC application is configured to match the further request to a policy element based on the information contained in the application request for a second AN parameter, especially to at least one of: interface node and/or interface node type, especially an interface node identifier or an object identifier, OID identifying the type of the interface node, especially a E2 node and/or E2 Service Model, E2SM; requested AN parameter, especially an object identifier, OID identifying a variable within a interface node or within a E2 Service Model; and requester AN-IC application, especially an xApp application identifier or rApp application identifier.

Other aspects, features, and advantages will be apparent from the summary above, as well as from the description that follows, including the figures and the claims.

The present invention aims at allowing the application of a security/privacy policy based on what information an AN-IC application is requesting, the identity of the requester and/or the target (e.g. E2 node) this request targets.

Parameters associated to the security/privacy policy are related to the data request, requester and request target, and are based on a combination of:
What INSM (e.g. E2 Service Model, E2SM) the request refers to, such as OID of the E2 service model and/or parameter(s) belonging to said E2 Service Model
Requester AN-IC application (e.g. xApp ID)
Request target, that is the AN component being queried (e.g. based on E2 node ID), which maps to a specific component (e.g. RU, CU, DU) providing the data.

FIG. 4 illustrates an example of parameters considered for RIC security policy according to an embodiment of the invention. The security/privacy policy 62 contains information what the action of the security policy should be regarding the information 20 flowing towards the AN-IC, and is mapped to an interface node 70, and/or applications 50 (e.g., xApps). The action can be one of the following: allow requested data; deny requested data; or modify the data so that it cannot be mapped 1:1 to the original data.

In particular, in accordance with an embodiment of the invention, the modification of data can be done, for example, via one or a combination of the following actions:
a. Suppression or generalization of data to achieve k-anonymity: i.e., replacing segments of subscriber identifiers with the same sequence of number; and/or
b. Adding noise to the data to achieve differential privacy: i.e., modifying the actual values such as KPIs being returned by the interface node; and/or
c. Generating synthetic data (i.e., “adding noise data points”) to add additional data points to the data set.

The modification of data in any of the above options is particularly preferred, since it has the advantage that it can maintain xApp functionality while still providing protection of the data being accessed by the xApp.

Regarding the mode of operation for the RIC security/privacy policies, two modes of operation are proposed in accordance with an embodiment of the invention.

In a first mode, the security/privacy policy is applied to data before it is stored in the AN-IC's database. That is, on the data flow between interface node and AN-IC. With this mode, in case of modification of the data, the original data is not available in the AN-IC, only the modified data.

In a second mode, the security/privacy policy is applied to data when it is requested by AN-IC applications. That is, on the data flow between AN-IC applications and AN-IC. Here, in the second mode, in case of modification of the data, the original data is available in the AN-IC.

A further mode of operation is considered, in which a second AN-IC application realizes the security/privacy functionality, wherein requests of an AN-IC application are performed towards the second AN-IC application, i.e. the second AN-IC application acts as a middleman to the requests of the AN-IC application and applies the security/privacy policies.

FIG. 5 illustrates an example method of the application of the security/privacy policy to received data from the interface node in accordance with an embodiment of the invention. In detail, FIG. 5 illustrates the interaction between the AN-IC application 50, the AN-IC 60 and the interface node 70. The method includes the following steps.

In step S1, the AN-IC application 50 sends a request of data to the AN-IC 60 (e.g. explicit data request, subscription to a certain kind of data).

In step S2, the security/privacy policy is applied to: grant the request, deny the request, or modify the data. If the request is denied, steps S2, S3 and S4 are skipped.

If the information is not available at the AN-IC 60, the information is requested, in step S3A, from the interface node 70 and is received, in step S3B, by the AN-IC 60.

In step S4, either before the information is stored in the AN-IC's shared data layer or after the information is stored in the shared data layer, the information is modified based on the security/privacy policy.

In step S5, if in step S2 the security/privacy policy indicates to deny, the application receives a message indicating the rejection of the request in step S1; if in step S2 the security/privacy policy indicates to modify, the application receives the modified information from the RIC 60.

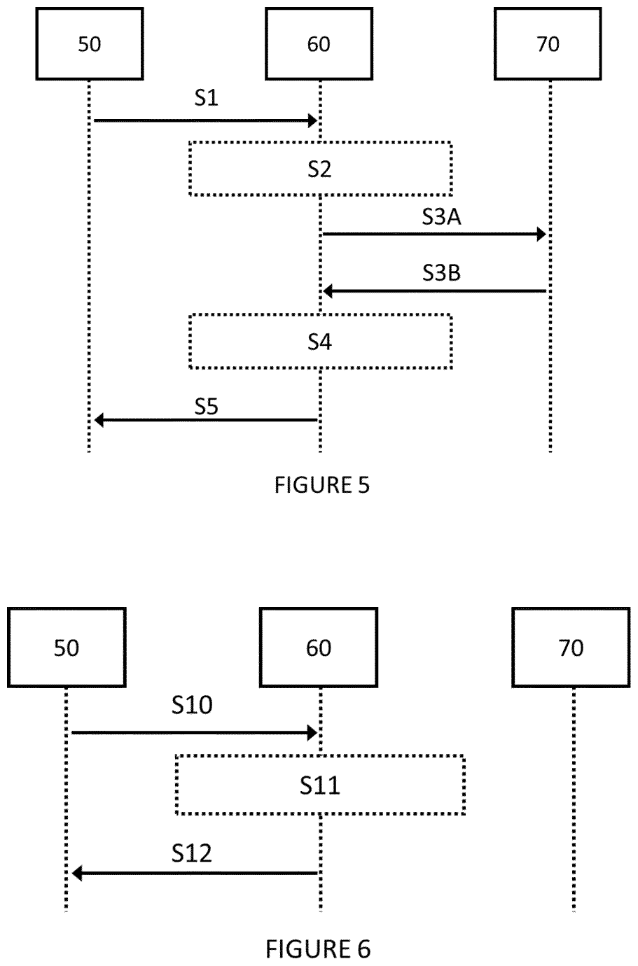

FIG. 6 illustrates an example method where the generation of synthetic data is not received from an interface node in accordance with an embodiment of the invention.

For generated or artificial data (i.e. “statistical noise”), the procedure is similar to that depicted in FIG. 5, with the exception that the information is not retrieved from the interface node, but rather generated by the AN-IC itself. In this case, the information returned by the AN-IC is not information originating from the interface node but rather generated by the AN-IC. In detail, the method of FIG. 6 has the following steps.

In step S10, the AN-IC application 50 sends a request of/subscription to data (e.g. an AN-IC parameter such as a KPI from a CU) to the AN-IC 60.

In step S11, the RIC 60 generates the generated or artificial data (e.g. a KPI value in the range based in the INSM).

In step S12, the AN-IC 60 sends a message to the application 50 containing the generated or artificial data.

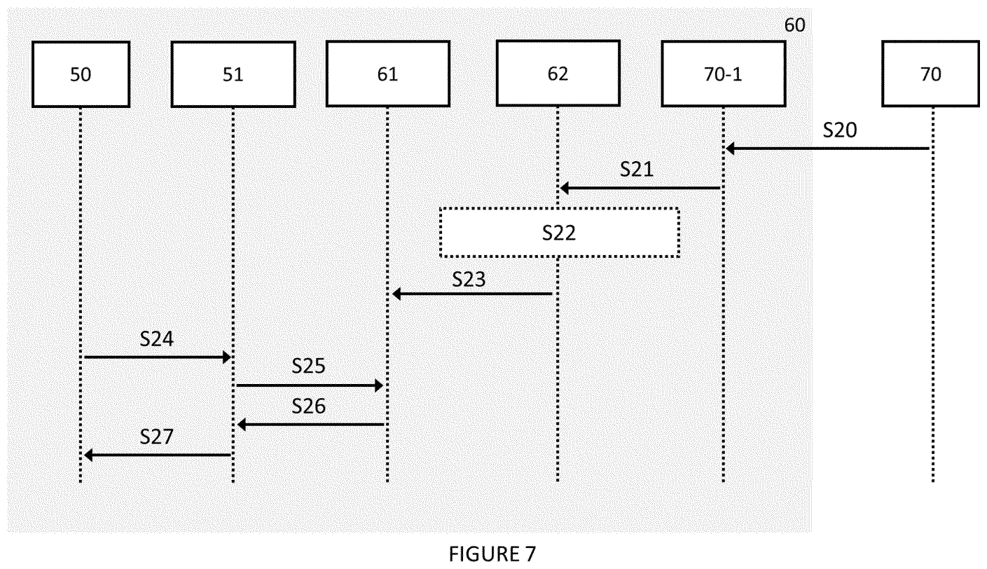

FIG. 7 illustrates an example method where modified data is written to a Shared Data Layer (SDL) or database (DB) 61 of the AN-IC 60 in accordance with an embodiment of the invention.

In step S20, the interface node 70 sends a message containing data to the interface termination point 70-1 (e.g. E2 termination point) within the AN-IC 60. Thereafter, the interface termination point 70-1 forwards, in step S21, the message to the security/privacy policy element 62.

In step S22, the security/privacy policy element 62 applies the security/privacy policy before the data is written into the DB or SDL 61.

In step S23, the modified data is stored in the data base or shared data layer 61.

In step S24, the application 50 sends a data request to the application API 51 (e.g. xApp API of the near-RT RIC). Here, the application API 51 forwards, in step S25 the data request to the DB or SDL 61.

In step S26, the DB or SDL 61 sends a response message including the modified data to application API 51.

Finally, in step S27, the application API 51 forwards the message containing the modified data to the application 50.

This mode has the advantage of computational simplicity and the fact that the original (that is, unmodified) data is not stored in the AN-IC. On the other hand, if pseudo-anonymized information is provided, as each AN-IC application 50 would receive the information concealed with the same mapping, it would be possible to track a given (anonymized) user across applications (e.g., across different xApps).

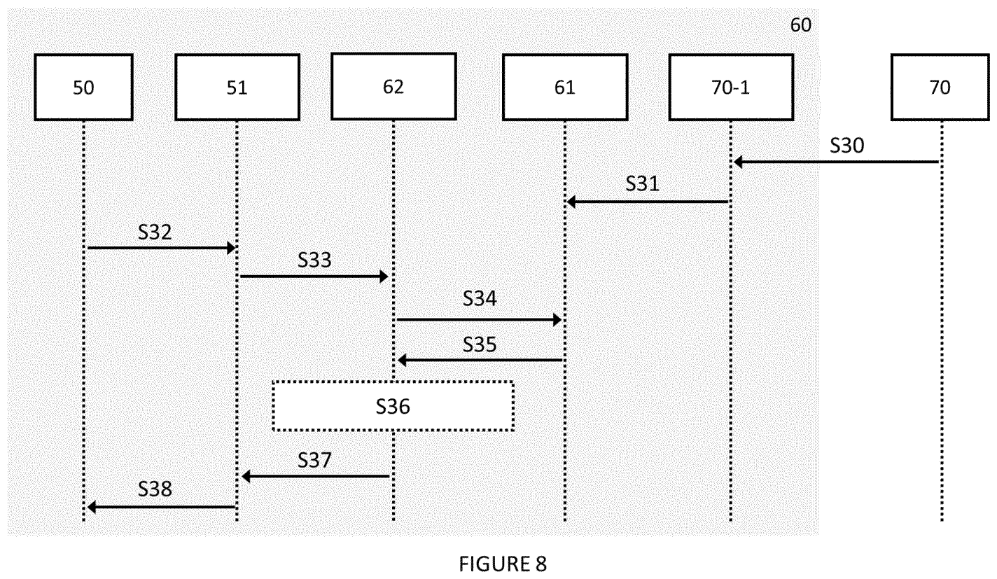

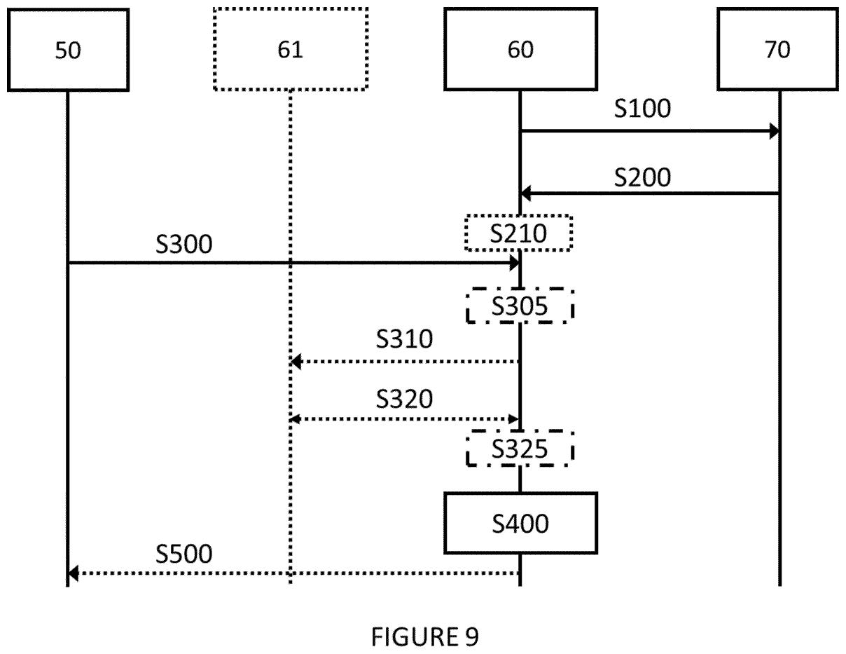

FIG. 8 illustrates an example method for the local mode where data is modified prior to being sent to the application in accordance with an embodiment of the invention.

In step S30, the interface node 70 sends a message containing data to the interface termination point 70-1. Thereafter, the interface termination point 70-1 forwards, in step S31, the message to the data base or shared data layer 61.

In step S32, the AN-IC application 50 sends a data request to the application API 51 (e.g. xApp API). Here, the application API 51 forwards, in step S33 the data request to the security/privacy policy element 62.

In step S34, the security/privacy policy element 62 sends a request to retrieve data to DB or SDL 61. In step S35, the security/privacy policy element 62 receives the retrieved data from the DB or SDL 61.

In step S36, the security/privacy policy element 62 applies the security/privacy policy before the data is send to the AN-IC application 50.

In step S37, the security/privacy policy element 62 sends a response message including the modified data to application API 51.

Finally, in step S38, the application API 51 forwards the message containing the modified data to the AN-IC application 50.

This mode has the advantage that each AN-IC application 50 (i.e., xApp) can potentially be served differently modified data sets, albeit at the cost of higher complexity and the need to store the original data in the AN-IC 60. While at the cost of complexity, using different identifier re-mappings, obfuscation and/or pseudo-anonymization algorithms for different AN-IC applications 50 has the advantage of making it impossible to track users across different AN-IC applications 50.

FIG. 9 illustrates an example method for enhancing privacy in an access network in accordance with an embodiment of the invention.

As shown in FIG. 9, the AN is comprised of several AN components and an AN Intelligent Controller 60 (AN-IC). In particular, at least one of the AN components contains an interface node 70, especially a E2 node.

In accordance with the embodiment, an AN-IC is composed of at least the following elements: an AN-IC application 50; one or more policy elements (not shown in FIG. 9); and one or more logical connections between the AN-IC 60 and the interface nodes 70 (e.g., a E2 interface).

The AN-IC application 50 can request and/or subscribe to one or more AN parameters from an interface node 70, via the AN-IC 60.

Further, each policy element contains a behavior to be applied to a matching requests or a related AN parameter. In this regard, a “behavior” may refer to: allowing/rejecting a request, modifying an AN parameter, and/or generating a further AN parameter analogous to the AN parameter.

In more detail, the meaning of the expression “modifying an AN parameter” may, but is not limited to, refer to: replacing, removing, re-mapping, hashing, encrypting, obscuring or otherwise altering AN parameters or parts thereof, especially in the case of AN parameters referring to one or more identifiers related to: a subscriber, area, AN component, time, network identifier and/or network area.

In this embodiment, the AN-IC 60 matches policy elements to matching requests. In more detail, the method comprises the following steps.

In step S100, the AN-IC 60 sends to an interface node 70 a request for an AN parameter related to the interface node 70.

In step S200, the AN-IC 60 receives from the interface node 70 an interface node message containing the AN parameter requested in the step S100.

In step S300, the AN-IC 60 receives from the AN-IC application 50 a further request for the AN parameter requested in the step S100.

In step S400, the AN-IC 60 matches the further request to a policy element based on the information contained in the further message request or interface node message. For example, the matching of the further request to a policy element may refer to at least one of the following:
interface node and/or interface node type, especially an interface node identifier or an object identifier, OID identifying the type of the interface node, especially a E2 node and/or E2 Service Model, E2SM;
requested AN parameter, especially an object identifier, OID identifying a variable within an interface node or within a E2 Service Model; and
requester AN-IC application 50, especially an xApp application identifier or rApp application identifier.

The method described above with reference to FIG. 9 may further comprise some additional elements and optional steps (denoted with dotted lines in FIG. 9) as explained below.

In a preferred embodiment, the AN may be a radio access network (RAN). Further, an AN component may be one of: a radio unit (RU); a central unit (CU); or a distributed unit (DU).

In a preferred embodiment, the method may further comprise a step S500 where the AN-IC 60 sends to the AN-IC application 50, a message which content depends on the indication by the matching behavior. For example, the message may comprise:
a further AN parameter analogous to the AN parameter, if the matching behavior indicates generating a further AN parameter analogous to the AN parameter;
a modified AN parameter derived from the AN parameter, if the matching behavior indicates modifying an AN parameter; and
a message rejecting the application request, if the matching behavior indicates rejecting the request.

In a preferred embodiment, the method may further comprise a step S210 where the AN-IC applies the behavior from the matching policy element to the AN parameter received in the receiving step S200.

In a preferred embodiment, the AN-IC may further comprise a Shared Data Layer (SDL) 61 for storing AN parameters. In that case, step S210 is not performed and the method may further comprise the following preferred alternatives.

In a preferred alternative, the method may further comprise a step S310 of storing, after the receiving step S200, by the AN-IC, the received AN parameter in the SDL 61. Once stored in the SDL 61, the AN-IC may retrieve, in step S320, the AN parameter from the SDL 61 and apply, in step S325, the behavior from the matching policy element to the retrieved AN parameter.

The above alternative has the advantage that each AN-IC application 50 (e.g., xApps/rApps) can potentially be served differently modified data sets, albeit at the cost of higher complexity and the need to store the original data in the AN-IC 60. While at the cost of complexity, using different identifier re-mappings for different AN-IC applications 50 has the advantage of making it impossible to track users across different AN-IC applications 50.

In an additional preferred alternative, the method may further comprise a step S305 of applying, by the AN-IC, the behavior from the matching policy element to the AN parameter, prior to the storing step S310. The step S310 is the same as the one described in the above preferred alternative. Thereafter, the AN-IC may already retrieve, in step S320, the AN parameter from the SDL 61.

The above alternative has the advantage of computational simplicity and the fact that the original (that is, unmodified) data is not stored in the AN-IC. On the other hand, even if pseudo-anonymized information is provided, it would be possible to track a given (anonymized) user across applications (e.g., xApps/rApps).

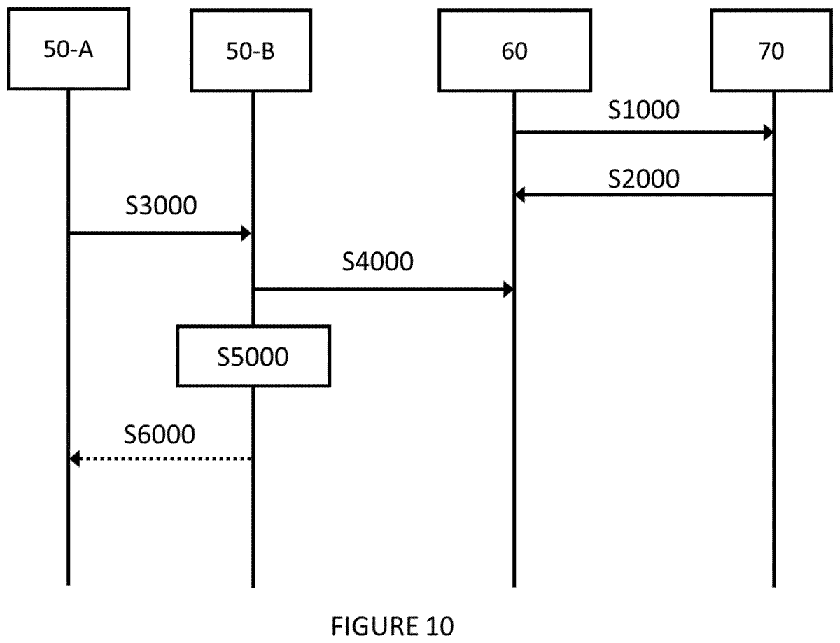

In an alternative implementation, FIG. 10 illustrates another example method for enhancing privacy in an access network in accordance with another embodiment of the invention. The embodiment illustrated in FIG. 10 differs from the one of FIG. 9 in that the above-described innovative functionality (performed mainly by the AN-IC in the embodiment of FIG. 9) is performed by a second AN-IC application 50-B, instead of the AN-IC. Therefore, although the implementation is different, the embodiments of FIGS. 9 and 10 are alternative solutions to the above-mentioned technical problem.

In detail, FIG. 10 illustrates a method for enhancing privacy in an access network.

As shown in FIG. 10, the AN is comprised of several AN components and an AN Intelligent Controller 60 (AN-IC). In particular, at least one of the AN components contains an interface node 70, especially a E2 node.

In accordance with the embodiment, an AN-IC is composed of at least the following elements: an application 50-A; an AN-IC application 50-B; one or more policy elements; and one or more logical connections between the AN-IC 60 and the interface nodes 70 (e.g., a E2 interface).

In this embodiment, the application 50-A can request and/or subscribe to one or more AN parameters from an interface node 70, via the AN-IC application 50-B. In addition, the AN-IC application 50-B can request and/or subscribe to one or more AN parameters from an interface node 70, via the AN-IC.

Further, each policy element contains a behavior to be applied to a matching requests or a related AN parameter. In this regard, a “behavior” may refer to: allowing/rejecting a request, modifying an AN parameter, and/or generating a further AN parameter analogous to the AN parameter.

In more detail, the meaning of the expression “modifying an AN parameter” may, but is not limited to, refer to: replacing, removing, re-mapping, hashing, encrypting, obscuring or otherwise altering AN parameters or parts thereof, especially in the case of AN parameters referring to one or more identifiers related to: a subscriber, area, AN component, time, network identifier and/or network area.

In this embodiment, differing from the embodiment of FIG. 9, it is the AN-IC application 50-B who matches policy elements to matching requests, instead of the AN-IC 60 in FIG. 9. In more detail, the method of FIG. 10 comprises the following steps.

In step S1000, the AN-IC sends to an interface node 70 a request for an AN parameter related to the interface node 70.

In step S2000, the AN-IC receives from an interface node 70 an interface node message containing the AN parameter requested in the step S1000.

In step S3000, the application 50-A sends to the AN-IC application 50-B an application request for a second AN parameter. Here, the second AN parameter relates to the AN parameter.

In more detail, information related to the second AN parameter is, either explicitly or implicitly, contained within the AN parameter, e.g. the second AN parameter is the AN parameter, the AN parameter is a parameter list and the second AN parameter is contained therein, the second AN parameter is obtained by processing the AN parameter (e.g. applying a bit mask and/or by arithmetic means).

In step S4000, the AN-IC receives from the AN-IC application 50-B a further request for the AN parameter. Here, the AN parameter relates to the second AN parameter.

In step S4500, the AN-IC application 50-B receives from the AN-IC a message containing the AN parameter requested in the further request in the step S4000.

In step S5000, the AN-IC application 50-B matches the further request to a policy element based on the information contained in the application request for a second AN parameter in the step S3000.

For example, the matching of the further request to a policy element may refer to at least one of the following:
interface node and/or interface node type, especially an interface node identifier or an object identifier, OID identifying the type of the interface node, especially a E2 node and/or E2 Service Model, E2SM;
requested AN parameter, especially an object identifier, OID identifying a variable within an interface node or within a E2 Service Model; and
requester AN-IC application, especially an xApp application identifier or rApp application identifier.

The method described above with reference to FIG. 10 may further comprise some additional elements and optional steps (denoted with dotted lines in FIG. 10) as explained below.

In a preferred embodiment, the method may further comprise a step S6000, where the AN-IC application 50-B sends to the application a message which content depends on the indication by the matching behavior. For example, the message may comprise:
a second further AN parameter analogous to the second AN parameter of step S3000, if the matching behavior indicates generating a further AN parameter analogous to the AN parameter;
a modified second AN parameter derived from the second AN parameter of step S3000, if the matching behavior indicates modifying an AN parameter; and
a message rejecting the application request, if the matching behavior indicates rejecting the request.

Although sometimes the invention has been illustrated and described in detail with reference to “RIC/RIC applications” or “Access node intelligent controllers (AN-IC)/AN-IC applications”, it is noted that the expressions “RIC/RIC applications” and “Access node intelligent controllers (AN-IC)/AN-IC applications” are fully interchangeable with each other in the context of an access network.

While the invention has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Furthermore, in the claims the word “comprising” does not exclude other elements or steps, and the indefinite article “a” or “an” does not exclude a plurality. A single unit may fulfill the functions of several features recited in the claims. The terms “essentially”, “about”, “approximately” and the like in connection with an attribute or a value particularly also define exactly the attribute or exactly the value, respectively. Any reference signs in the claims should not be construed as limiting the scope.

1: A method for enhancing privacy in an access network (AN) comprising one or more AN components and an AN Intelligent Controller (AN-IC), wherein at least one AN component contains an interface node, wherein the AN-IC comprises:
an AN-IC application configured to request and/or subscribe to one or more AN parameters from the interface node, via the AN-IC;
one or more policy elements, each policy element containing a behavior to be applied to a matching requests or a related AN parameter, wherein the behavior corresponds to allowing/rejecting a request, modifying an AN parameter and/or generating a further AN parameter analogous to the AN parameter; and
one or more logical connections between the AN-IC and one or more interface nodes;
wherein the method comprises:
sending, by the AN-IC to the interface node, a request for an AN parameter related to the interface node;
receiving, by the AN-IC from the interface node, an interface node message containing the requested AN parameter;
receiving, by the AN-IC from the AN-IC application, a further request for the AN parameter; and
matching, by the AN-IC, the further request to a policy element based on the information contained in the further message request or interface node message.

2: The method of claim 1, further comprising:
sending, by the AN-IC to the AN-IC application, a message;
wherein the message comprises:
in case of the matching behavior indicating generating a further AN parameter analogous to the AN parameter, a further AN parameter analogous to the AN parameter;
in case of the matching behavior indicating modifying an AN parameter, a modified AN parameter derived from the AN parameter; or
in case of the matching behavior indicating rejecting the request, a message rejecting the application request.

3: The method of claim 1, wherein the AN is a radio access network (RAN), and wherein a respective AN component is a radio unit (RU), a central unit (CU), or a distributed unit (DU); and/or
wherein modifying a respective AN parameter corresponds to replacing, removing, re-mapping, hashing, encrypting, obscuring or otherwise altering AN parameters or parts thereof.

4: The method of claim 1, further comprising:
applying, by the AN-IC, the behavior from the matching policy element to the received AN parameter.

5: The method of claim 1, wherein the AN-IC further comprises a Shared Data Layer (SDL) configured to store AN parameters, and wherein the method further comprises:
after the receiving, storing, by the AN-IC, the received AN parameter in the SDL.

6: The method of claim 5, further comprising:
after the storing, retrieving, by the AN-IC, the AN parameter from the SDL; and
applying, by the AN-IC, the behavior from the matching policy element to the retrieved AN parameter.

7: The method of claim 5, further comprising:
before the storing, applying, by the AN-IC, the behavior from the matching policy element to the AN parameter; and
after the storing, retrieving, by the AN-IC, the AN parameter from the SDL.

8: A method for enhancing privacy in an access network (AN) comprising one or more AN components and an AN Intelligent Controller (AN-IC) wherein each AN component contains an interface node, and wherein the AN-IC comprises:
an application configured to request and/or subscribe to one or more AN parameters from the interface node, via an AN-IC application;
the AN-IC application, wherein the AN-IC application is configured to request and/or subscribe to one or more AN parameters from the interface node, via the AN-IC;
one or more policy elements, each policy element containing a behavior to be applied to a matching requests or a related AN parameter, wherein the behavior corresponds to allowing/rejecting a request, modifying an AN parameter and/or generating a further AN parameter analogous to the AN parameter; and
one or more logical connections between the AN-IC and one or more interface nodes;
wherein the method comprises:
sending, by the AN-IC to the interface node, a request for an AN parameter related to the interface node;
receiving, by the AN-IC from the interface node, an interface node message containing the requested AN parameter;
sending, by the application to the AN-IC application, an application request for a second AN parameter, wherein the second AN parameter relates to the AN parameter;
receiving, by the AN-IC from the AN-IC application, a further request for the AN parameter, wherein the AN parameter relates to the second AN parameter;
receiving, by the AN-IC application from the AN-IC, a message containing the AN parameter requested in the further request; and
matching, by the AN-IC application, the further request to a policy element based on the information contained in the application request for the second AN parameter.

9: The method of claim 8, further comprising:
sending, by the AN-IC application to the application, a message;
wherein the message comprises:
in case of the matching behavior indicating generating a further AN parameter analogous to the AN parameter, a second further AN parameter analogous to the second AN parameter;
in case of the matching behavior indicating modifying an AN parameter, a modified second AN parameter derived from the second AN parameter; or
in case of the matching behavior indicating rejecting the request, a message rejecting the application request.

10: An access network (AN), comprising:
one or more AN components, wherein at least one AN component contains an interface node; and
an AN Intelligent Controller (AN-IC);
wherein the AN-IC comprises:
an AN-IC application configured to request and/or subscribe to one or more AN parameters from the interface node, via the AN-IC;
one or more policy elements, each policy element containing a behavior to be applied to a matching requests or a related AN parameter, wherein the behavior corresponds to allowing/rejecting a request, modifying an AN parameter and/or generating a further AN parameter analogous to the AN parameter; and
one or more logical connections between the AN-IC and one or more interface nodes; and
wherein the AN-IC is configured to:
send, to an interface node, a request for an AN parameter related to the interface node;
receive, from the interface node, an interface node message containing the requested AN parameter;
receive, from the AN-IC application, a further request for the requested AN parameter; and
match the further request to a policy element based on the information contained in the further message request or interface node message.

11: The AN of claim 10, wherein the AN is a radio access network (RAN), and wherein a respective AN component is radio unit (RU), a central unit (CU), or a distributed unit (DU); and
wherein the AN-IC is configured to send to the AN-IC application, a message, wherein the message comprises:
in case of the matching behavior indicating generating a further AN parameter analogous to the AN parameter, a further AN parameter analogous to the AN parameter;
in case of the matching behavior indicating modifying an AN parameter, a modified AN parameter derived from the AN parameter; or
in case of the matching behavior indicating rejecting the request, a message rejecting the application request.

12: The AN of claim 10, wherein modifying the AN parameter corresponds to replacing, removing, re-mapping, hashing, encrypting, obscuring or otherwise altering AN parameters or parts thereof; and/or
wherein the AN-IC is further configured to apply the behavior from the matching policy element to the AN parameter received from the interface node.

13: The AN of claim 10, wherein the AN-IC further comprises a Shared Data Layer (SDL) configured to store AN parameters, and wherein the AN-IC is further configured to:
store, after receiving the further request for the requested AN parameter, the received AN parameter in the SDL;
retrieve the AN parameter from the SDL; and
apply the behavior from the matching policy element to the retrieved AN parameter.

14: The AN of claim 10, wherein the AN-IC further comprises a Shared Data Layer (SDL) configured to store AN parameters, and wherein the AN-IC is further configured to:
apply the behavior from the matching policy element to the AN parameter;
store, after receiving the further request for the requested AN parameter, the received AN parameter in the SDL; and
retrieve the AN parameter from the SDL.

15: An access network (AN), comprising:
one or more AN components, wherein each AN component contains an interface node; and
an AN Intelligent Controller, wherein the AN-IC comprises:
an application configured to request and/or subscribe to one or more AN parameters from an interface node, via an AN-IC application;
the AN-IC application, wherein the AN-IC application is configured to request and/or subscribe to one or more AN parameters from a respective interface node, via the AN-IC;
one or more policy elements, each policy element containing a behavior to be applied to a matching request or a related AN parameter, wherein the behavior corresponds to allowing/rejecting a request, modifying a AN parameter and/or generating a further AN parameter analogous to the AN parameter; and
one or more logical connections between the AN-IC and one or more interface nodes;
wherein the AN-IC is configured to:
send, to an interface node, a request for an AN parameter related to the interface node; and
receive, from the interface node, an interface node message containing the requested AN parameter;
wherein the application is configured to send, to the AN-IC application, an application request for a second AN parameter, wherein the second AN parameter relates to the AN parameter;
wherein the AN-IC is further configured to receive, from the AN-IC application, a further request for the AN parameter, wherein the AN parameter relates to the second AN parameter; and
wherein the AN-IC application is configured to:
receive, from the AN-IC, a message containing the AN parameter requested in the further request; and
match the further request to a policy element based on the information contained in the application request for a second AN parameter.

16: The method of claim 1, wherein the further request is matched to at least one of:
an interface node and/or interface node type;
a requested AN parameter; or
a requester AN-IC application.

17: The method of claim 16, wherein the interface node and/or the interface node type is an interface node identifier or an object identifier (OID) identifying the type of the interface node.

18: The method of claim 16, wherein the requested AN parameter is an object identifier (OID) identifying a variable within an interface node or within an E2 Service Model (E2SM).

19: The method of claim 16, wherein the requester AN-IC application is an xApp application identifier or rApp application identifier.
